(19) United States
(12) Patent Application Publication
(10) Pub. No.: US 2009/0259774 A1
(43) Pub. Date: Oct. 15, 2009

(54) IDENTITY-DISTINGUISHABLE SENSING METHOD AND SYSTEM

(75) Inventor: Po-Huan Chen, Taipei (TW)

Correspondence Address: BACON & THOMAS, PLLC, 625 SLATERS LANE, FOURTH FLOOR, ALEXANDRIA, VA, 22314-1176, US

(73) Assignee: ASUSTek COMPUTER INC., Taipei (TW)

(21) Appl. No.: 12/394,937

(22) Filed: Feb. 27, 2009

(30) Foreign Application Priority Data
Apr. 11, 2008 (TW) 97113380

(51) Int. Cl. G06F 3/00; G06F 7/04

(52) U.S. Cl. 710/16; 340/5.64

(57) ABSTRACT

A method and system for sensing identity-distinguishable applied to a computer are provided. The computer includes a detecting unit and a logging-in/out unit. The detecting unit is used for detecting an identifying chip having an identifying data. The logging-in/out unit is used for logging in the computer system by a personal identification data matching with the identifying data. The identity-distinguishable sensing method includes the following steps. Firstly, the identifying chip is detected. Next, the computer is logged in by the personal identification data matching with the identifying data.

This application claims the benefit of Taiwan application Serial No. 97113380, filed Apr. 11, 2008, the subject matter of which is incorporated herein by reference.

### BACKGROUND OF THE INVENTION

1. Field of the Invention

The invention relates in general to a sensing method and system, and more particularly to an identity-distinguishable sensing method and system applied in a computer.

2. Description of the Related Art

With the rapid advance in information technology, computer has become an important device in people's everyday life. Due to the features of fast calculation speed, high storage capacity, low power consumption and small volume, computer has been regarded as a powerful data operation and processing device as well as been widely used in various fields such as engineering, medicine, semiconductor and finance and.

As more and more texts and data are digitalized for the convenience of data processing and data storage in computer, the privacy and security for the data stored in the computer have been paid much attention. At present, several accounts of independent authority can be set in one computer, and the data of each individual account is encrypted and stored according to the requirement of each account. However, the access to an account is normally controlled by a password only, so the security protection is not reliable. Furthermore, other unauthorized users may access the computer to get the data stored in the computer if the previous user left the computer without shutting down or logging off the computer. Under such circumstance, the data is easily accessed, changed or stolen.

Also, the user is usually required to manually input the login data such as account name and password into the computer before using the computer. When the user has to leave the computer and wants to log out or shut down the computer, the user still has to manually log out or shut down the computer. To the worse, the user has to wait until the computer is indeed logged out or shut down before the user can leave the computer. The above procedures of logging-out or shutting down the computer manually cannot avoid data being divulged due to the user's negligence. Moreover, the manual procedure of logging out and shutting down computer is time-consuming such that the user is unable to leave the computer immediately.

### SUMMARY OF THE INVENTION

The invention is directed to an identity-distinguishable sensing method and system applied in a computer. When an identifying chip is detected, the computer is automatically logged in by a personal identification data matching with an identifying data of the identifying chip without using manual logging procedure. Also, it is assured that the data stored in the computer will not be accessed or changed by any unauthorized users, so the data privacy is guaranteed.

According to a first aspect of the present invention, an identity-distinguishable sensing method applied in a computer is provided. Firstly, an identifying chip having an identifying data is detected. Next, the computer is logged in by a personal identification data matching with the identifying data.

According to a second aspect of the present invention, an identity-distinguishable computer including a detecting unit and a logging-in/out unit is provided. The detecting unit is used for detecting an identifying chip having an identifying data. The logging-in/out unit is used for logging in the computer system with a personal identification data matching with the identifying data.

According to a third aspect of the present invention, an identity-distinguishable sensing system including an identifying chip and a computer is provided. The identifying chip has an identifying data. The computer includes a detecting unit and a logging-in/out unit. The detecting unit is used for detecting the identifying chip. The logging-in/out unit is used for logging in the computer system by a personal identification data matching with the identifying data.

The invention will become apparent from the following detailed description of the preferred but non-limiting embodiments. The following description is made with reference to the accompanying drawings.

### BRIEF DESCRIPTION OF THE DRAWINGS

FIG. 1 shows a flowchart of an identity-distinguishable sensing method according to a preferred embodiment of the invention;

FIG. 2 shows a functional block diagram of an identity-distinguishable sensing system and a computer according to a preferred embodiment of the invention; and

FIG. 3 shows another functional block diagram of an identity-distinguishable sensing system and a computer according to a preferred embodiment of the invention.

### DETAILED DESCRIPTION OF THE INVENTION

In the identity-distinguishable sensing method, the computer and the identity-distinguishable sensing system of a preferred embodiment of the invention, as long as an identifying chip is detected, the on/off status and the log-in status of a computer are determined, such that the computer is started-up/shut-down or logged-in/out automatically. As the user does not need to start-up/shut-down or log-in/out the computer manually, the computer is user-friendly. Furthermore, the security of the computer is enhanced by way of identifying the user's personal identification data. The invention is elaborated below by way of examples and in terms of preferred embodiments, and it is to be understood that the example and preferred embodiments are for exemplification only not for limiting the scope of protection of the invention. Also, secondary elements are omitted in the embodiments to highlight the technical features of the invention.

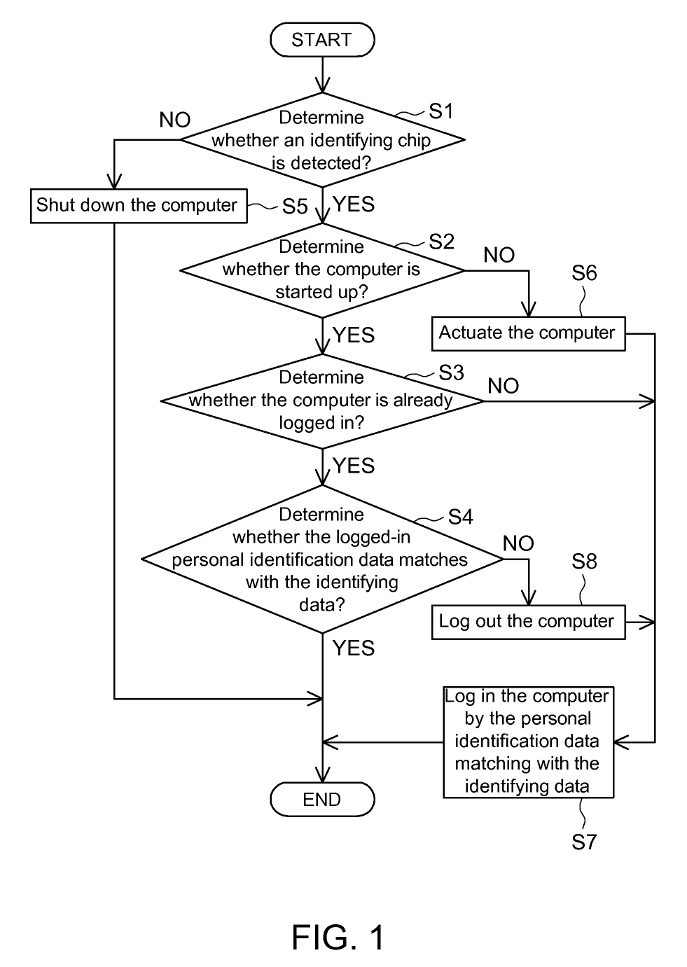

The identity-distinguishable sensing method according to the embodiment of the invention is described below. The identity-distinguishable sensing method includes the following steps. Firstly, an identifying chip with an identifying data is detected. Next, the computer is logged in by a personal identification data matching with the identifying data when the identifying chip is detected. Referring to FIG. 1, a flowchart of an identity-distinguishable sensing method according to a preferred embodiment of the invention is shown. The identity-distinguishable sensing method of the embodiment of the invention includes the following steps. Firstly, the method begins at step S1, whether an identifying chip having an identifying data is detected is determined. Next, as the identifying chip is detected, an on/off status of the computer is determined and then whether the computer is started up is determined as shown in step S2. Then, when the computer is determined as having been started up, the computer is logged in by the personal identification data matching with the identifying data as shown in step S7. Thus, the computer can be logged in by different personal identification data of different identifying chips, such that the identity of the user who logs in the computer is monitored, and data privacy and security are guaranteed.

On the other hand, as the identifying chip is not detected in step S1, the computer is shut down as shown in step S5. Furthermore, the user can pre-set whether to shut down or to log out the computer if the identifying chip is not detected in step S1. Moreover, as the identifying chip is not detected, the computer can be shut down or logged out after a delay time according to user's setting. In step S2, if the computer is not started up, the method proceeds to step S6 that the computer is actuated such that the computer enters a start-up status. Then the method proceeds to S7, the computer is logged in by the personal identification data matching with the identifying data.

After step S2, the embodiment of the invention further includes the following steps. In step S2, if the computer is started up, the identity-distinguishable sensing method proceeds to step S3 to determine whether the computer is logged in. If it is determined that the computer is not logged in, the method proceeds to step S7 to log in the computer by the personal identification data matching with the identifying data. In step S3, if the computer is logged in, the method proceeds to step S4 to determine whether the logged-in personal identification data matches with the identifying data. Next, in step S4 if the logged-in personal identification data does not match with the identifying data, the computer is logged out as shown in step S8 and the method proceeds to step S7, the computer is logged in by the personal identification data matching with the identifying data. On the other hand, instep S4 if the logged-in personal identification data matches with the identifying data, the identity-distinguishable sensing method terminates. In the present embodiment of the invention, step S1 preferably is executed continually such that whether an identifying chip is detected so as to perform corresponding procedure constantly.

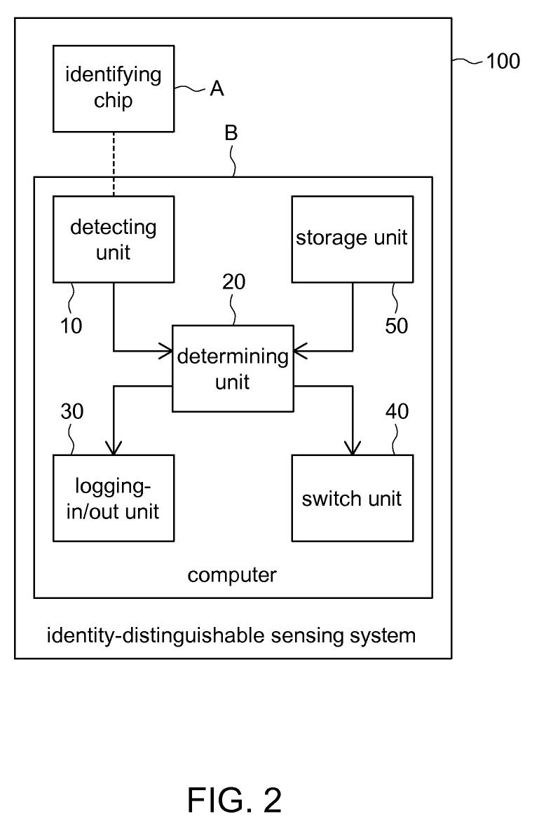

The identity-distinguishable sensing system of a preferred embodiment of the invention is disclosed below. FIG. 2 shows a functional block diagram of an identity-distinguishable sensing system and a computer according to a preferred embodiment of the invention. The identity-distinguishable sensing system 100 includes an identifying chip A and a computer B. The identifying chip A has an identifying data. The computer B includes a detecting unit 10, a determining unit 20 and a logging-in/out unit 30. The detecting unit 10 is used for detecting the identifying chip A. The identifying chip A is, for example, a radio frequency identification (RFID) chip, and the detecting unit 10 is, for example a radio frequency sensor. The radio frequency sensor detects the existence of the radio frequency identification chip within a detecting area ranging about 1 meter.

In the identity-distinguishable sensing system 100 of the present embodiment of the invention, the determining unit 20 is used for determining the on/off status of the computer B when the identifying chip A is detected by the detecting unit 10. For example, when the identifying chip A is within the range of the detecting area, the identifying chip A is detected by the detecting unit 10, meanwhile, the determining unit 20 determines whether the computer B is started up or shut down. In addition, the determining unit 20 is further used for determining the log-in status of the computer B when the computer B is determined as having been started up. The determining unit 20 is further used for determining whether a logged-in personal identification data matches with the identifying data of the identifying chip A when the computer B is determined as having been logged in.

The logging-in/out unit 30 is used for logging in the computer by the personal identification data matching with the identifying data B when the computer B is started up. In practical application, if the determining unit 20 determines that the computer B is started up but is not logged in, the logging-in/out unit 30 logs in the computer B. Moreover, if the determining unit 20 determines that the logged-in personal identification data does not match with the identifying data, then the logging-in/out unit 30 is further used for logging out the computer B and then logging in the computer B again by the personal identification data matching with the identifying data. By doing so, it is assured that the personal identification data logging in the computer B matches with the identifying data of the identifying chip A detected by the detecting unit 10, such that the data privacy and security corresponding to different identities of the computer B are guaranteed. According to the settings predetermined by the user, the logging-in/out unit 30 can log out the computer B if the detecting unit 10 does not detect any identifying chip A. Thus, it is ensured that when the user leaves the computer B, the data stored in the computer B and belonged to the identifying data of this user will not be accessed or changed by other users.

Furthermore, the computer B of the present embodiment of the invention includes a switch unit 40 and a storage unit 50. The switch unit 40 is used for actuating the computer B to enter a start-up status when the determining unit 20 determines that the computer B is shut down. According to the settings predetermined by the user, the switch unit 40 can shut down the computer B if the identifying chip A is not detected by the detecting unit 10 so as to enhance the security of the data that is stored in the computer B corresponding to this user. Moreover, the storage unit 50 is used for storing many items of personal identification data that match with the identifying data, such that the computer B is able to identify the identifying data of different users.

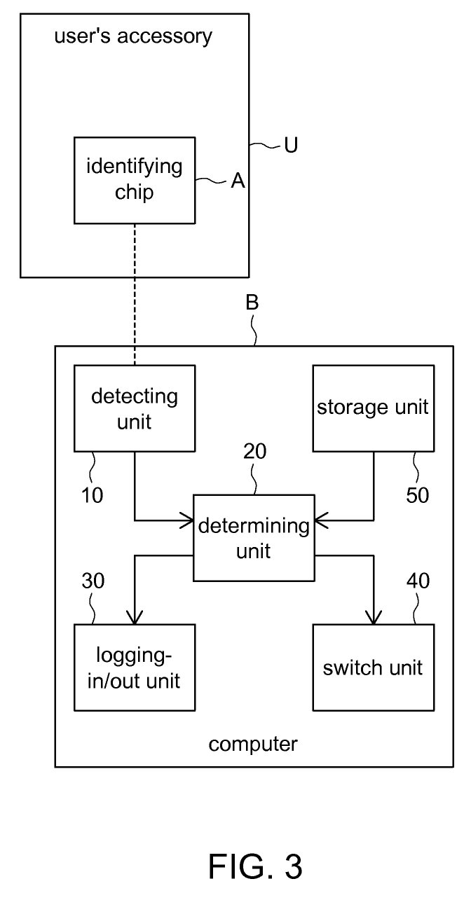

Please refer to both FIG. 3 and FIG. 2. FIG. 3 shows another functional block diagram of an identity-distinguishable sensing system and a computer according to a preferred embodiment of the invention. In the present embodiment of the invention, the identifying chip A can be integrated with a user's accessory U such as a key ring, a mobile phone strap, a necklace, a bracelet or a ring. When the user is outside the detecting area, the identifying chip A cannot be detected by the detecting unit 10, so the computer B will be logged out or shut down by the logging-in/out unit 30 or the switch unit 40 according to the settings predetermined by the user. When the user is located in the detecting area, the detecting unit 10 is able to detect the identifying chip A, so the computer B will be actuated, logged out or logged in according to the disclosure in step S2 and subsequent steps.

According to the identity-distinguishable sensing method, the computer and the identity-distinguishable sensing system of the embodiment of the invention disclosed above, the computer is shut down, actuated, or logged out/in according to the determination that whether the computer is started up, whether the computer is logged out, and whether the personal identification data for logging in the computer matches with the identifying data as long as an identifying chip is detected. Thus, when the user moves close to the computer, the computer is automatically started up, and the computer is automatically logged in by the personal identification data matching with the identifying data of the identifying chip carried by the user. Also, when the user leaves the computer, the computer is automatically logged out or shut down without any complicated logging procedure, ensuring that the data stored in the computer will not be accessed or changed by any unauthorized users, and further enhancing data privacy and security.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An identity-distinguishable sensing method for being applied in a computer, comprising the steps of:
detecting an identifying chip having an identifying data; and
logging in the computer by a personal identification data matching with the identifying data.

2. The identity-distinguishable sensing method according to claim 1, further comprising the step of:
determining an on/off status of the computer, wherein the computer is actuated to enter a start-up status if the computer is determined as having been shut down.

3. The identity-distinguishable sensing method according to claim 1, further comprising the steps of:
determining a log-in status of the computer; and
determining whether a logged-in personal identification data matches with the identifying data if the computer is already logged in.

4. The identity-distinguishable sensing method according to claim 3, further comprising the steps of:
logging out the computer if the logged-in personal identification data does not match with the identifying data; and
logging in the computer by the personal identification data matching with the identifying data.

5. The identity-distinguishable sensing method according to claim 1, wherein the step of detecting the identifying chip comprises:
using a radio frequency sensor to sense whether a radio frequency identification (RFID) chip is located in a detecting area.

6. The identity-distinguishable sensing method according to claim 1, further comprising the step of:
continually detecting the identifying chip.

7. The identity-distinguishable sensing method according to claim 6, further comprising step:
shutting down the computer if the identifying chip is not detected.

8. The identity-distinguishable sensing method according to claim 6, further comprising the step of:
logging out the computer if the identifying chip is not detected.

9. An identity-distinguishable computer, comprising:
a detecting unit used for detecting an identifying chip having an identifying data; and
a logging-in/out unit used for logging in the computer by a personal identification data matching with the identifying data.

10. The computer according to claim 9, further comprising:
a determining unit used for determining an on/off status of the computer as the identifying chip is detected by the detecting unit.

11. The computer according to claim 10, further comprising:
a switch unit used for actuating the computer to enter a start-up status as the determining unit determines that the computer is shut down.

12. The computer according to claim 11, wherein the switch unit is further used for shutting down the computer as the identifying chip is not detected by the detecting unit.

13. The computer according to claim 10, wherein the determining unit is further used for determining a log-in status of the computer as the computer is determined as having been started up.

14. The computer according to claim 13, wherein the determining unit is further used for determining whether a logged-in personal identification data matches with the identifying data as the computer is determined as having been logged in.

15. The computer according to claim 14, wherein the logging-in/out unit is further used for logging out the computer as the determining unit determines that the logged-in personal identification data does not match with the identifying data.

16. The computer according to claim 9, wherein the identifying chip is a radio frequency identification chip.

17. The computer according to claim 9, further comprising:
a storage unit used for storing a plurality of items of personal identification data matching with the identifying data.

18. An identity-distinguishable sensing system, comprising:
an identifying chip having an identifying data; and
a computer, comprising:
a detecting unit used for detecting the identifying chip; and
a logging-in/out unit used for logging in the computer by a personal identification data matching with the identifying data.

19. The identity-distinguishable sensing system according to claim 18, wherein the computer further comprises:
a determining unit used for determining an on/off status of the computer as the identifying chip is detected by the detecting unit.

20. The identity-distinguishable sensing system according to claim 19, wherein the computer further comprises:
a switch unit used for actuating the computer to enter a start-up status as the determining unit determines that the computer is shut down.

21. The identity-distinguishable sensing system according to claim 18, wherein the identifying chip is a radio frequency identification chip.

22. The identity-distinguishable sensing system according to claim 18, wherein the computer further comprises:
a storage unit used for storing a plurality of items of personal identification data matching with the identifying data.
